(19) United States
(12) Patent Application Publication
(10) Pub. No.: US 2011/0129112 A1
(43) Pub. Date: Jun. 2, 2011

(54) EXCITER APPARATUS

(75) Inventor: Masahiro SATOH, Kobe-shi (JP)

(73) Assignee: FUJITSU TEN LIMITED, Kobe-shi (JP)

(21) Appl. No.: 12/946,237

(22) Filed: Nov. 15, 2010

(30) Foreign Application Priority Data
Nov. 30, 2009 (JP) 2009-271335

(51) Int. Cl. H04R 1/00

(52) U.S. Cl. 381/413

(57) ABSTRACT

An exciter apparatus outputs a sound by vibrating an interior material of a vehicle. The exciter apparatus includes a base part attachable to the interior material, a magnetic circuit generating a magnetic field in a space between a permanent magnet and a magnetic body member, a voice coil fixed to the base part and located in the space, and a damper part which is elastically deformable, is formed outside an outer circumference of the base part, and is connected to the magnetic body member.

### BACKGROUND OF THE INVENTION

1. Field of the Invention

The invention relates to an exciter apparatus for generating sounds.

2. Description of the Background Art

A loudspeaker, outputting a sound by converting an electrical audio signal into a sound, includes a diaphragm and an exciter apparatus that vibrates the diaphragm. When an electrical audio signal is input to the exciter apparatus, the exciter apparatus vibrates the diaphragm, to generate a sound. The exciter apparatus includes a voice coil and a magnetic circuit. The electrical audio signal is input to the voice coil. The magnetic circuit, having a permanent magnet and a yoke, generates a magnetic field around the voice coil.

For example, Japanese Patent No. 3949273 discloses a flat-panel loudspeaker including a plate diaphragm whose central part is connected to an exciter. Japanese Patent Laid-open Publication No. 2006-115167 also discloses a loudspeaker for installation in a ceiling base material of a vehicle, which is successful in shortening the distance between the ceiling base material and the top of an installed exciter apparatus.

As for an exciter apparatus generating a sound by vibrating an interior material of a vehicle, the installation of the exciter apparatus is under space limitations. For example, when installing the exciter apparatus in a limited space between a ceiling material and a ceiling of the vehicle, such a space in a small-size vehicle is generally narrower than that in a big-size vehicle. For meeting the space limitations, it is desired to make an exciter apparatus thinner as much as possible.

### SUMMARY OF THE INVENTION

In one aspect of the invention, an exciter apparatus for generating a sound by vibrating an interior material of a vehicle includes: a base part that is attachable to the interior material; a magnetic circuit that includes a permanent magnet and a magnetic body, generating a magnetic field in a space between the permanent magnet and the magnetic body; a voice coil that is fixed to the base part and that is located in the space; and a damper part that is elastically deformable and that is disposed outside an outer circumference of the base part, the damper part being connected to the magnetic body.

The damper part is formed outside the outer circumference of the base part and is connected to the magnetic body of the magnetic circuit. Therefore the structure does not require the double layer layout with the damper part and the base part. As a result, the structure allows the exciter apparatus to become thinner as a whole.

In another aspect of the invention, the magnetic body includes a yoke part having the permanent magnet inside of the yoke part, and a flange part formed outside an outer circumference of the yoke part, and the damper part is connected to the flange part.

The damper part outside the base part can be connected to the magnetic circuit easily.

In another aspect of the invention, the flange part includes an inner circumference part connected to the outer circumference of the yoke part, and an outer circumference part connected to the damper part, a rise connecting an outer portion of the inner circumference part to an inner portion of the outer circumference part such that the outer circumference part is disposed farther away from the interior material that is the inner circumference part, and the damper part is located within a space between the outer circumference part and the interior material.

While ensuring enough space for the damper part to be set, the magnetic circuit is located closer to the interior material. The structure described above allows the exciter apparatus as a whole to become thinner.

In another aspect of the invention, the magnetic circuit generates a magnetic field that causes the interior material to output only a sound in a range of frequencies higher than a reference frequency.

A design requirement of the magnetic circuit is eased relating to the magnetic body that forms the magnetic circuit. The eased requirement increases the flexibility of the design of the flange part formed in the magnetic body. This means it is possible to design a shape of the flange part more freely with a view to make the exciter apparatus thinner as a whole. As a result, the exciter apparatus is made successfully thinner as a whole.

In another aspect of the invention, an exciter apparatus for generating a sound by vibrating an interior material of a vehicle includes: a base part that is attachable to the interior material; a magnetic circuit that has a permanent magnet and a magnetic body, generating a magnetic field in a space between the permanent magnet and the magnetic body; a voice coil that is fixed to the base part that is located in the space. The magnetic body has: a yoke part having the permanent magnet inside the yoke part; and a damper part that is elastically deformable and that is formed outside an outer circumference of the yoke part, the damper part being connected to the base part.

The magnetic body includes the damper part outside the outer circumference of the yoke part. Since the damper part is connected to the base part, it is not required for the damper part and the yoke part to be located in the double layer. As a result, the structure allows the exciter apparatus as a whole to become thinner.

Therefore, an object of the invention is to provide a thinner exciter apparatus.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 shows an appearance perspective view of an exciter apparatus.

FIG. 2 shows an internal structure diagram of the exciter apparatus.

FIG. 3 shows an exploded view of the exciter apparatus.

FIG. 4 shows a bottom view of the exciter apparatus.

FIG. 5 shows a top view of the exciter apparatus.

FIG. 6 shows an appearance perspective view of an exciter apparatus for a comparative example.

FIG. 7 shows an internal structure diagram of the exciter apparatus for the comparative example.

FIG. 8 shows an exploded view of the exciter apparatus for the comparative example.

FIG. 9 shows a top view of the exciter apparatus for the comparative example.

FIG. 10 shows a bottom view of the exciter apparatus for the comparative example.

FIG. 11 shows a bottom view of an exciter apparatus for a modification example.

FIG. 12 shows an appearance perspective view of an exciter apparatus for another modification example.

### DESCRIPTION OF THE EMBODIMENTS

### Representative Embodiment

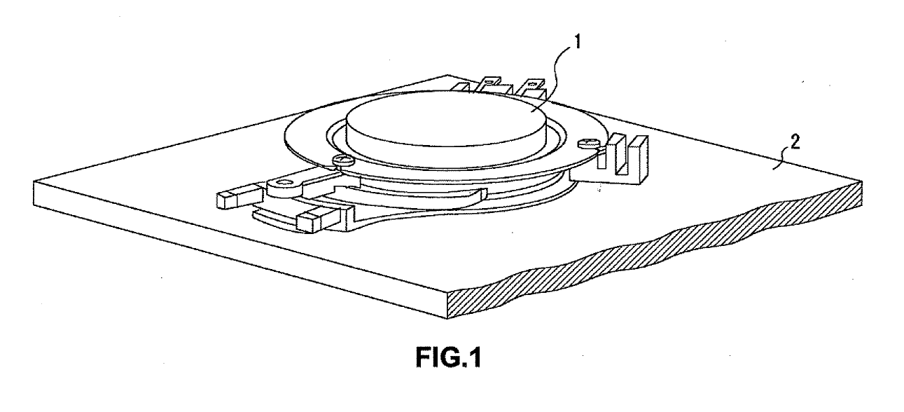

Hereinafter, a representative embodiment of the invention will be described. FIG. 1 is an appearance perspective view showing an exciter apparatus 1 of the embodiment. The exciter apparatus 1, as in FIG. 1, is attachable to an interior material 2 of a vehicle. Combination of the exciter apparatus 1 and the interior material 2 function as a loudspeaker in which the interior material 2 is used as a diaphragm. In other words, the exciter apparatus 1 vibrates the interior material 2, to generate sounds.

Generally, an audio system, installed as standard equipment in a vehicle, has a cone loudspeaker at the lower part of a door. The sounds from the loudspeaker set at a lower part in a vehicle cabin lack a broadening sense of sounds. In an example of the common measure to compensate for this lack, the electrical audio signals prior to input to a loudspeaker are processed in advance by digital signal processing technology. However, even such digital signal processing technology cannot fully compensate for the lack of the broadening sense of sounds:

The exciter apparatus 1 of the embodiment is intended to compensate for the lack of the broadening sense of sounds in a vehicle cabin. To attain the object effectively, the exciter apparatus 1 is installed onto interior materials, especially a ceiling material, for example, in the vehicle cabin. For more details, the exciter apparatus 1 is attachable to an area of the ceiling behind the front seat. The exciter apparatus 1 installed provides sounds to passengers in the vehicle from above. As a result, the installation compensates effectively for the lack of the broadening sense of sounds above the passengers in the vehicle. To implement this installation, it is required that the exciter apparatus becomes especially thinner enough to be installed in such a ceiling material under many space limitations.

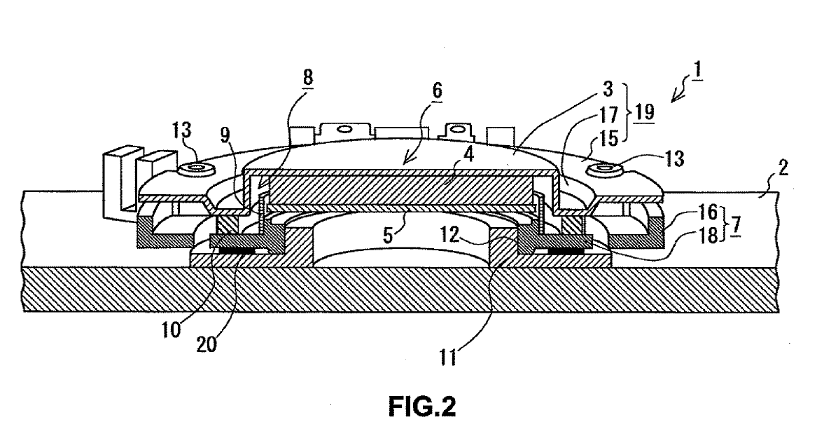

The exciter apparatus 1 includes the following to allow for installation in such the ceiling material under many space limitations. FIG. 2 shows an internal structure diagram of the exciter apparatus 1.

The exciter apparatus 1, as in FIG. 2, includes a magnetic body member 19 having a yoke part 3, a magnet 4 of a permanent magnet, and a magnetic circuit 6 having a plate 5. Besides, the exciter apparatus 1 includes a chassis 7 supporting the magnetic circuit 6, a voice coil 9, and a dustproof spacer 10 preventing foreign substances from getting into a space inside the yoke part 3. The voice coil 9 is located in a magnetic field 8 generated by the magnetic circuit 6 between the yoke part 3 and the magnet 4.

The exciter apparatus 1 is attachable to the interior material 2 when the chassis 7 is screwed to a holder 11 bonded to the interior material 2 at a screw part 12. In a gap between the chassis 7 and the holder 11, a spacer 20 made of a foam material such as urethane or rubber is inserted. The spacer 20 prevents the screw part 12 from loosening by its surface frictional force that is generated by compression when the chassis 7 is screwed to the holder 11.

The voice coil 9 is fixed to the chassis 7. The chassis 7 moves relative to the magnetic circuit 6 by Lorentz Force when the electrical audio signals flow through the voice coil 9. The relative movement of the chassis 7 to the magnetic circuit 6 causes the interior material 2 to move, to generate sounds.

The interior material 2 here is an interior material of a ceiling part in a vehicle cabin. The exciter apparatus 1 is installed in a space between the interior material 2 and a sheet metal that is an exterior material of a vehicle. This space, in an ordinary case, has only a height of approximately between a dozen millimeters and dozens of millimeters. Thus, it is required that an apparatus should be thinner for installation in such a space.

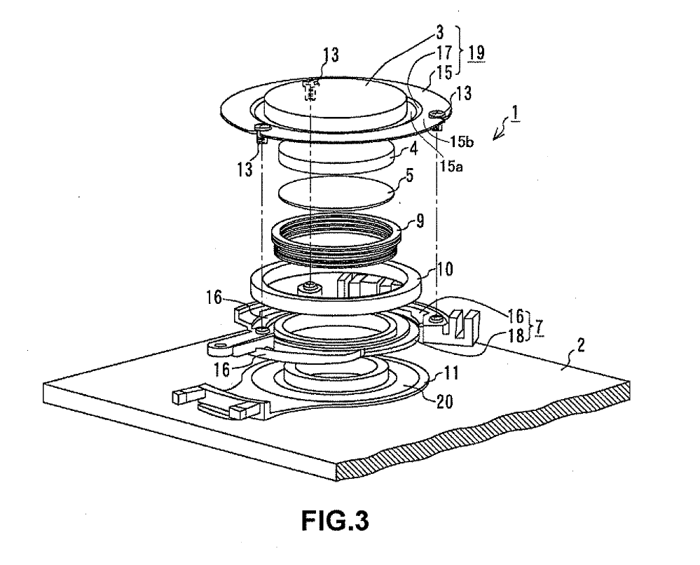

FIG. 3 shows an exploded view of the exciter apparatus 1. As is clear from FIG. 3, the magnetic body member 19 having the yoke part 3 includes a flange part 15 of a flanged shape. The flange part 15 is designed in a ring shape spread around the bottom end of the outer circumference of the yoke part 3 (the end on the side of the interior material 2) that covers the magnet 4. The flanged shape of the flange part 15 is effective to enhance a heat release of the magnetic circuit 6 due to the expanded surface area of the magnetic body member 19, and is useful for joining with a damper part 16 included in the chassis 7.

The flange part 15 included in the magnetic body member 19 has an inner circumference part 15a and an outer circumference part 15b. A rise 17 connects between the inner circumference part 15a and the outer circumference part 15b (at an outer end of the inner circumference part 15a). The outer circumferential end of the flange part 15 is higher than a root part. In other words, the outer circumference part 15b of the flange part 15 is set at a wider space from the interior material 2 (that is the chassis 7) than that of the inner circumference part 15a connected to the outer circumference of the yoke part 3. The damper part 16 is located in the space secured between the outer circumference part 15b of the flange part 15 and the interior material 2. This allows the magnetic circuit 6 to be located closer to the interior material 2 (that is the chassis 7), while locating the damper part 16 appropriately. As a result, the exciter apparatus 1 can become thinner. Further, by ensuring the space for the length of a screw 13 that fastens the flange part 15 and the damper parts 16, the strength of the connection part is increased, where the flange part 15 and the damper part 16 are fastened.

The magnetic body member 19 having this shape of the flange part 15 tends to leak more magnetic fluxes than a member with no part of the flange part 15. However, the exciter apparatus 1 is designed to compensate for the lack of the broadening sense of sounds in a vehicle cabin on the assumption that the exciter apparatus 1 covers only mid- to high-frequency ranges; for example, ranges of frequencies of over-400 Hz. In other words, the exciter apparatus 1 is designed so that the magnetic circuit 6 can form the magnetic field 8 that causes the interior material 2 to output only the sounds in a range higher than a reference frequency (400 Hz in the embodiment).

The exciter apparatus 1 is designed to become thinner as a matter of priority instead of covering a wider range. In particular, the magnetic body member 19 is made of a thinner member, and further, is designed with the flange part 15 of the shape as above. Adopting such a structure allows the apparatus to cover at least mid- to high-frequency ranges required to enhance the broadening sense of sounds, while the structure limits the range for playable sounds. Such a design concept is seen throughout the exciter apparatus 1. For example, a gap between the voice coil 9 and the magnetic circuit 6 is narrower than the ones of general exciter apparatuses. This is because the exciter apparatus 1 does not require a large space for the voice coil 9 and the magnetic circuit 6 to move relative to each other, by abandoning covering of a low-frequency range.

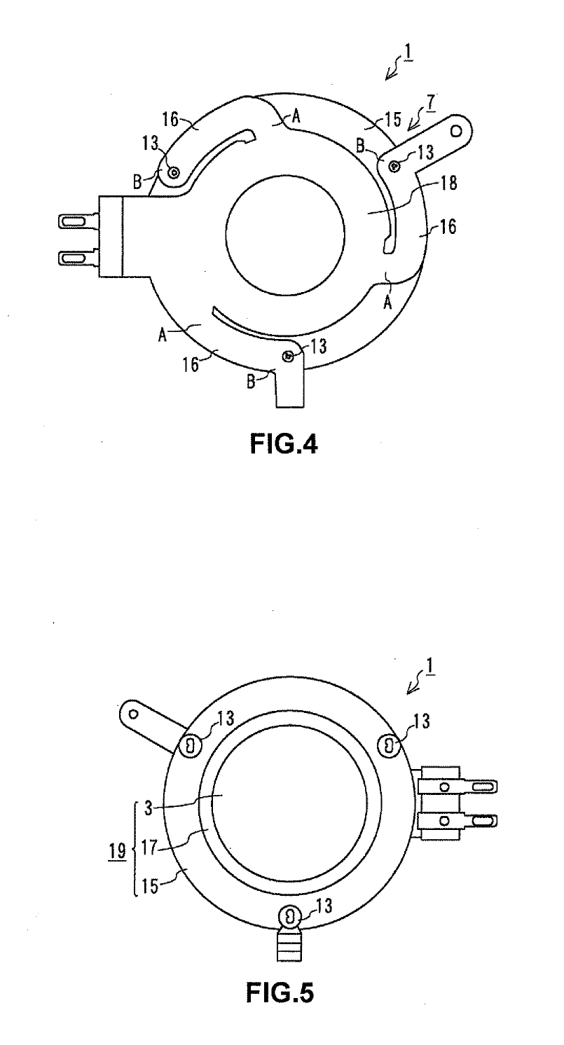

The magnetic circuit 6 is formed by the cooperation of the magnetic body member 19 as above, the magnet 4 and the plate 5, and is supported by three pieces of the damper part 16 included in the chassis 7. FIG. 4 shows a bottom view (view from the side of the interior material 2) and FIG. 5 shows a top view (view from an opposite side of the interior material 2) of the exciter apparatus 1.

The chassis 7, as in FIG. 4, includes three pieces of the damper part 16, and a base part 18 which is annular and has an approximately circular outer shape. The base part 18 and the damper part 16 are integrally formed of the same member which is elastically deformable. The three pieces of the damper part 16 are respectively-elongated members and protrude outside from the outer circumference of the base part 18. Further, the three pieces of the damper part 16 respectively extend around the circumference of the base part 18. This allows a root part A of the damper part 16 and an end part B on the opposite side of the damper part 16 to move relative to each other along a sound axis of the exciter apparatus 1. The root part A is a connection part with the base part 18.

The base part 18 has screw grooves in its inner circumference part, shaping a female screw of the screw part 12. The screw grooves engage with screw grooves shaping a male screw of the screw part 12 formed at the holder 11. With this engagement using the holder 11, the base part 18 of the chassis 7 is attachable to the interior material 2.

The end part B of the damper part 16, as in FIG. 5, is connected to the flange part 15 of the magnetic body member 19 by the screw 13. The connection may be made by using a rivet, for example, instead of the screw 13. The magnetic circuit 6 is supported by the damper part 16 protruding outside from the outer circumferential end of the base part 18 attachable to the interior material 2. In this structure, the magnetic circuit 6 moves relative to the base part 18 due to the electrical audio signals flowing to the voice coil 9. This relative movement, together with an inertial force of the magnetic circuit itself, vibrates the interior material 2.

As explained above, the exciter apparatus 1 has the damper part 16 formed outside the outer circumference of the base part 18. This structure does not require the double layer layout along the sound axis with the damper part 16 and the base part 18. As a result, the exciter apparatus 1 can become thinner.

A connection member between the damper part 16 and the base part 18 is not necessary since they are integrally formed of the same member. This also allows the exciter apparatus 1 as a whole to become much thinner.

The damper part 16 includes at least one elongated member. This also allows the damper part 16 which is elastically deformable to be formed easily by selecting materials and dimensions appropriately. The damper part 16 extends around the circumference of the base part 18. This also allows the damper part 16 to ensure the required length easily.

The damper part 16 is connected to the flange part 15 formed outside the outer circumference of the yoke part 3. This structure allows the damper part 16 formed outside the base part 18 to be connected easily to the magnetic circuit 6.

The flange part 15 includes the outer circumference part 15b formed with a rise at the inner circumference. The damper part 16 is located within the space between the outer circumference part 15b and the interior material 2. This also allows the magnetic circuit 6 to be located closer to the interior material 2, so that the exciter apparatus 1 as a whole can become thinner.

The above-described exciter apparatus lean drastically become thinner compared to conventional apparatuses. This allows an exciter apparatus to be located within a narrow space where its installation has conventionally been impossible, for example, the space between the interior material and the ceiling of a small-size vehicle.

### Comparative Example

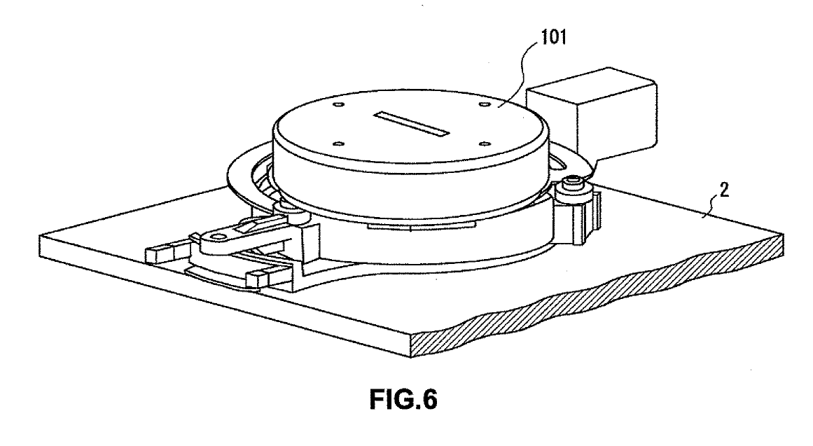

Next, a comparative embodiment will be described. FIG. 6 shows an appearance perspective view of an exciter apparatus 101 for a comparative example. The exciter apparatus 101 is designed so as not to limit the range for playable sounds. The exciter apparatus 101 is attachable to the interior material 2 in the same way as the exciter apparatus 1 described above.

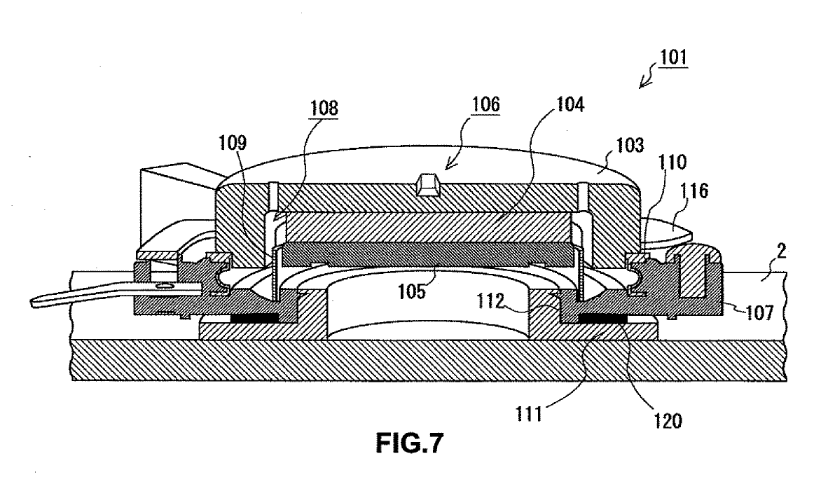

FIG. 7 shows an internal structure diagram of the exciter apparatus 101 for the comparative example. The exciter apparatus 101, as in FIG. 7, includes a magnetic circuit 106 including a yoke 103, a magnet 104 and a plate 105. Besides, the exciter apparatus 101 includes a damper part 116 connected to the outer circumference of the yoke 103, a chassis 107 supporting the magnetic circuit 106 via the damper part 116, a voice coil 109, and a dustproof spacer 110 preventing foreign substances from getting into the space inside the yoke 103. The voice coil 109 is located in a magnetic field 108 generated between the yoke 103 and the magnet 104 by the magnetic circuit 106.

The chassis 107 is fastened at a screw part 112 to a holder 111 bonded to the interior material 2. A spacer 120 is inserted between the chassis 107 and the holder 111 for preventing the screw part 112 from loosening.

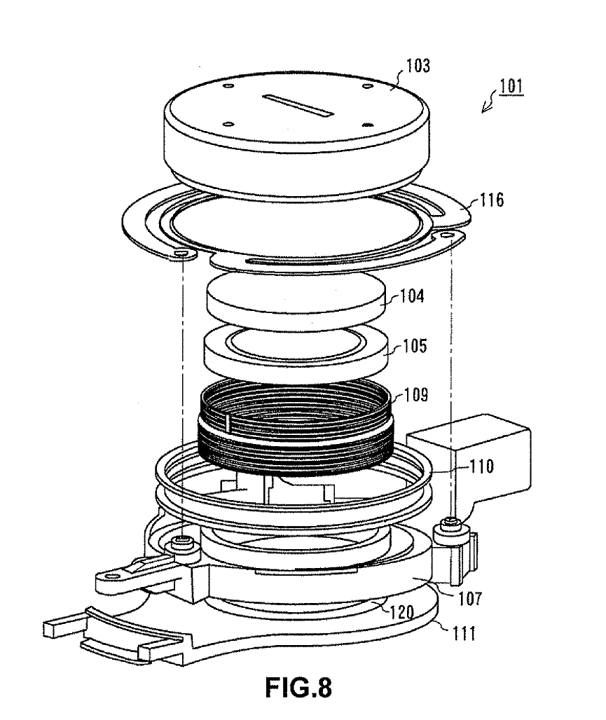

FIG. 8 shows an exploded view of the exciter apparatus 101. As is clear from FIG. 8, the exciter apparatus 101 has the yoke 103 with the damper part 116 attached instead of the flange part 15 of a flanged shape, differing from the exciter apparatus 1 described above. The damper part 116 is made of a nonmagnetic body which is elastic. The inner circumference face of the damper part 116 touches to the bottom of the yoke 103 and is connected to outer circumference of the yoke 103, by caulking, for example. On the other hand, the yoke 103 made of a magnetic body has enough thickness to cover the wider range. A space between the chassis 107 and the plate 105 is also wider than that of the exciter apparatus 1 above in order to cover the wider range.

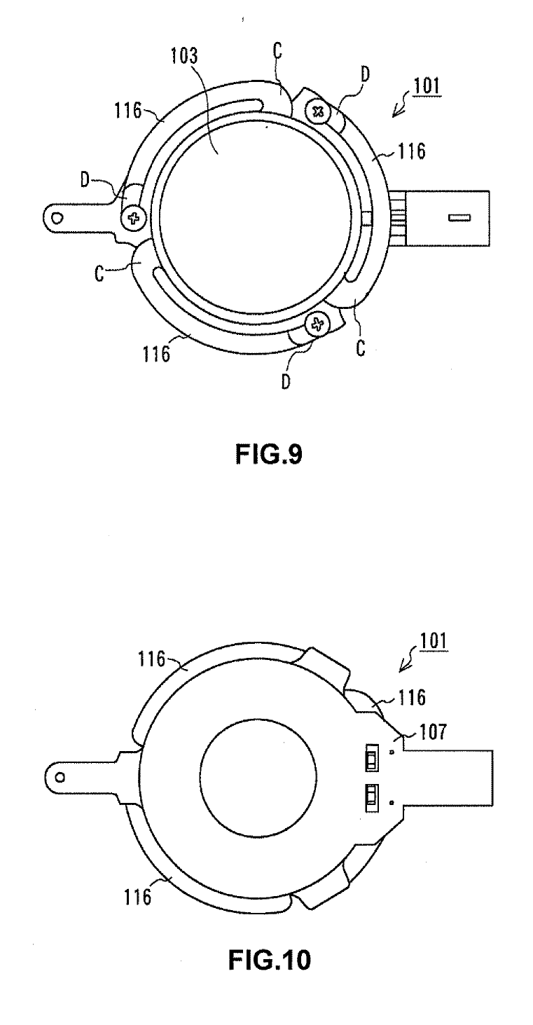

The magnetic circuit 106, formed by the cooperation of the magnet 104, the plate 105 and the yoke 103 described as above, is supported by the damper part 116 fastened to the chassis 107. FIG. 9 shows a top view and FIG. 10 shows a bottom view of the exciter apparatus 101. A root part C of the damper part 116 is a connection part with the yoke 103. The root part C and the end part D on the opposite side from the root part C can move relative to each other along the sound axis of the exciter apparatus 101. The magnetic circuit 106 is supported on the chassis 107 by the damper part 116 having the above structure. In this structure, the magnetic circuit 106 moves relative to the chassis 107 due to the electrical audio signals flowing to the voice coil 109. This relative movement, together with an inertial force of the magnetic circuit itself vibrates the interior material 2.

The yoke 103 of the exciter apparatus 101 in the comparative example is thicker than the yoke part 3 of the representative embodiment. To connect the chassis 107 and the magnetic circuit 106 which are made of different members respectively, it is required for the chassis 107 and the damper part 116 to be set up in a double layer along the sound axis. The damper part 116 adds its thickness to that of the exciter apparatus 101. Therefore, it is difficult to make the exciter apparatus 101 thinner, unlike the exciter apparatus 1 of the representative embodiment.

The exciter apparatus 101 of the comparative example requires approx. 17 mm in thickness (height) in order to gain the volume and the range enough to compensate for the lack of broadening sense of sounds above passengers in a vehicle. On the other hand, the exciter apparatus 1 of the representative embodiment described above is approx. 11 mm in thickness (height), which shows the success in becoming drastically thinner.

### Modification Example

Hereinafter, a modification example will be described. All embodiments including the representative embodiment above and the embodiments described hereafter can be combined arbitrarily.

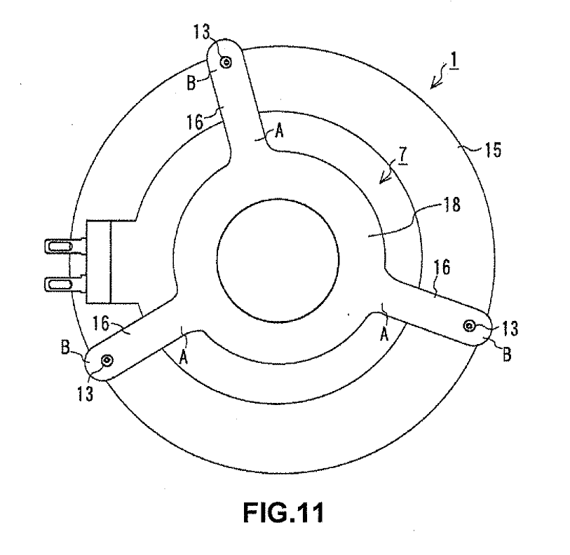

The exciter apparatus 1 described above in the representative embodiment includes three pieces of the damper part 16. On the other hand, an exciter apparatus may include, for example, four or more pieces of the damper part 16. The exciter apparatus 1 above has the damper part 16 extending around the circumference. On the other hand, an exciter apparatus may have the damper part 16 which is located radially, extending outwardly from the outer circumference of the base part 18, as in FIG. 11.

The chassis 7 of the exciter apparatus 1 of the representative embodiment above includes the damper part 16. On the other hand, a magnetic body member may include a damper part.

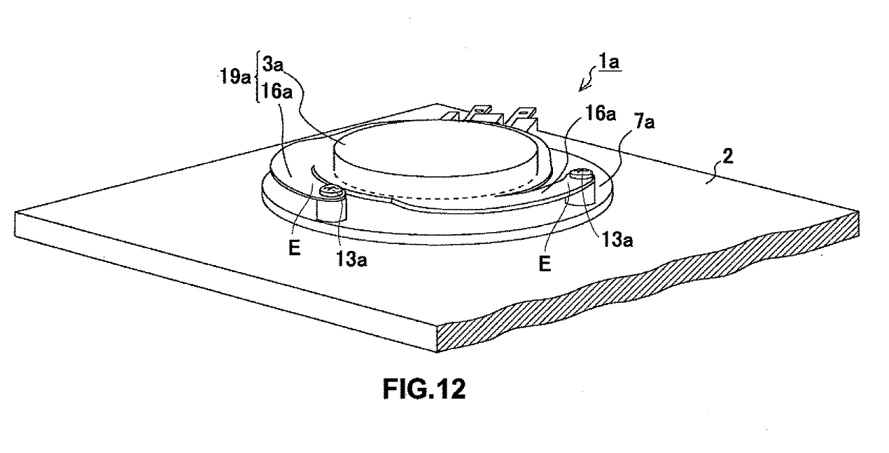

FIG. 12 shows an appearance perspective view of an exciter apparatus 1a for a modification example described above. The exciter apparatus 1a includes a yoke part 3a, a damper part 16a and a chassis 7a in the same way as the exciter apparatus 1 of the representative embodiment above. The exciter apparatus 1a is also designed to compensate for the lack of the broadening sense of sounds in a vehicle cabin based on covering only mid- to high-frequency ranges. Hereinafter, it is described about differences of the exciter apparatus 1a of the modification example from the exciter apparatus 1 of the representative embodiment.

One difference of the exciter apparatus 1a from the exciter apparatus 1 is the location of the damper part 16a. In the exciter apparatus 1 of the representative embodiment, the damper part 16 is located at the chassis 7. On the other hand, in the exciter apparatus 1a of the modification example, the damper part 16a is located at a magnetic body member 19a that is a magnetic body material forming the yoke part 3a, and the chassis 7a functions only as a base part. The yoke part 3a of a cylindrical shape and the damper part 16a including at least one elongated member are integrally formed of the same member which is elastically deformable. The damper part 16a is formed in the shape protruding outside from the bottom edge of the outer circumference of the yoke part 3a whose outer shape is approximately circular (the edge on the side of the interior material 2). The damper part 16a extends around the circumference. An end part E of the damper part 16a is connected by a screw 13a to the chassis 7a attachable to the interior material 2.

In the above-described exciter apparatus 1a, the damper part 16a is formed outside the outer circumference of the yoke part 3a. This structure does not require a double layer with the damper part 16a and the yoke part 3a located along the sound axis. This allows the exciter apparatus 1a to become thinner with the simplified structure of the exciter apparatus 1a as a whole. The exciter apparatus 1a does not require a connection member between the damper part 16a and the yoke part 3a since they are integrally formed of the same member. This also allows the exciter apparatus 1a as a whole to become much thinner.

While the invention has been shown and described in detail, the foregoing description is in all aspects illustrative and not restrictive. It is therefore understood that numerous other modifications and variations can be devised without departing from the scope of the invention.

What is claimed is:

1. An exciter apparatus for generating a sound by vibrating an interior material of a vehicle, the apparatus comprising:
a base part that is attachable to the interior material;
a magnetic circuit that includes a permanent magnet and a magnetic body, generating a magnetic field in a space between the permanent magnet and the magnetic body;
a voice coil that is fixed to the base part and that is located in the space; and
a damper part that is elastically deformable and that is disposed outside an outer circumference of the base part, the damper part being connected to the magnetic body.

2. The exciter apparatus of claim 1, wherein
the damper part and the base part are integrally formed of a same member.

3. The exciter apparatus of claim 2, wherein
the damper part includes at least one elongated member.

4. The exciter apparatus of claim 3, wherein
the base part is a member having an outer circumference that is approximately circular, and
the damper part extends around the outer circumference of the base part.

5. The exciter apparatus of claim 1, wherein
the magnetic body includes
a yoke part having the permanent magnet inside of the yoke part and
a flange part formed outside an outer circumference of the yoke part, and the damper part is connected to the flange part.

6. The exciter apparatus of claim 5, wherein
the flange part includes
an inner circumference part connected to the outer circumference of the yoke part, and
an outer circumference part connected to the damper part, a rise connecting an outer portion of the inner circumference part to an inner portion of the outer circumference part such that the outer circumference part is disposed farther away from the interior material that is inner circumference part, and
the damper part is located within a space between the outer circumference part and the interior material.

7. The exciter apparatus of claim 1, wherein
the magnetic circuit generates a magnetic field that causes the interior material to output only a sound in a range of frequencies higher than a reference frequency.

8. An exciter apparatus for generating a sound by vibrating an interior material of a vehicle, the apparatus comprising:
a base part that is attachable to the interior material;
a magnetic circuit that includes a permanent magnet and a magnetic body, generating a magnetic field in a space between the permanent magnet and the magnetic body; and
a voice coil that is fixed to the base part and that is located in the space,
the magnetic body including:
a yoke part having the permanent magnet inside the yoke part, and
a damper part that is elastically deformable and that is formed outside an outer circumference of the yoke part, the damper part being connected to the base part.

9. The exciter apparatus of claim 8, wherein
the damper part and the yoke part are integrally formed of a same member.

10. The exciter apparatus of claim 9, wherein
the damper part is includes at least one elongated member.

11. The exciter apparatus of claim 10, wherein
the yoke part is a member having an outer circumference that is approximately circular, and
the damper part extends around the outer circumference of the yoke part.

12. The exciter apparatus of claim 11, wherein
the magnetic circuit generates a magnetic field that causes the interior material to output only a sound in a range of frequencies higher than a reference frequency.
